(19) United States
(12) Patent Application Publication
(10) Pub. No.: US 2017/0124602 A1
(43) Pub. Date: May 4, 2017

(54) DEMAND MATCHING METHOD ON NETWORK AND WORKSPACE TRADING PLATFORM USING SUCH METHOD

(71) Applicant: ABLE WORLD INTERNATIONAL LIMITED, Virgin Islands, British (VG)

(72) Inventors: WAI-TUNG CHEUNG, Hong Kong (HK); CHUN-HSIAO LIN, New Taipei City (TW); SHIH-CHENG LAN, Taipei City (TW); HO-CHEUNG CHEUNG, Hong Kong (HK)

(73) Assignee: ABLE WORLD INTERNATIONAL LIMITED, Virgin Islands, British (VG)

(21) Appl. No.: 15/319,167

(22) PCT Filed: Jul. 2, 2015
(86) PCT No.: PCT/CN2015/083158

§ 371 Date: Dec. 15, 2016

Related U.S. Application Data
(63) Continuation-in-part of application No. 14/577,772, filed on Dec. 19, 2014.
Application No. 14/577,772 is a continuation-in-part of application No. 14/324,069, filed on Jul. 3, 2014, now Pat. No. 9,134,963.
Application No. PCT/CN2015/083158 is a continuation-in-part of application No. 14/325,466, filed on Jul. 8, 2014.

(30) Foreign Application Priority Data
Jan. 4, 2015 (CN) 201510003718.0

(51) Int. Cl. G06Q 30/02; G06Q 30/06

(52) U.S. Cl. CPC G06Q 30/0277; G06Q 30/0605; G06Q 30/0645; G06Q 30/0273; G06Q 50/01

(57) ABSTRACT

A demand matching method on network and a workspace trading platform using the method are provided. The demand matching method is executed by a machine with computational capability. The demand matching method includes the following steps. Firstly, a first demand request is received from a first user. The first demand request corresponds to a business logic computation act, and the business logic computation act is a workspace. Then, a second demand request is received from a second user. If the first demand request and the second demand request accord with each other are matched, the business logic computation act corresponding to the first demand request is performed. In other words, the present invention provides an environment and platform for network users to achieve benefits through the creation of their own values while possessing industrial values.

### TECHNICAL FIELD

The present invention relates to a networking method, and more particularly to a demand matching method on network and a workspace trading platform using the method.

### BACKGROUND

With the rapid development of the internet technology, information can be propagated more quickly. Consequently, various web platforms and various software tools have been developed for people to use, and brought more efficient lives to the users. Moreover, the mobile network technology also allows people to communicate with other people over the world to transmit and share information through mobile devices. Accordingly, the rapid rise of e-commerce, online games and online marketing applications also bring enormous economic values.

Especially, the network marketing has become one of the most widely-used marketing tools because the business owners take a fancy to the benefits of network marketing applications (e.g., high propagation speed and the limitation breakage of the time and space). For example, the business owners would like to post advertisements about the objects to be sold on the widely-used internet search engine (e.g., Yahoo®), the high popularity blog space (e.g., Facebook® timeline) or the video player network platform (e.g., Youtube®) in order to achieve greater advertising effectiveness.

These business owners spend enormous cost on online marketing advertisement every year. In addition, most of their interests are distributed to few companies such as Yahoo® Company, Facebook® Company or Youtube® Company. It is unfair because the general people cannot achieve the desired profit easily. For example, a well-known blogger diligently manages a Facebook® timeline and makes the timeline highly popular with many fans. If the advertisements of the business owners are placed on the web page of the timeline of the blogger, the advertising effectiveness is satisfied because the fans of the timeline become the targets to be promoted. However, the well-known blogger does not have the ownership of the timeline and the well-known blogger is only able to manage and operate the timeline. Since Facebook® Company has the ownership of the timeline, the advertisement prices paid by the business owners become the profits of Facebook® Company. That is, the well-known blogger who diligently manages the timeline cannot get rewarded.

Therefore, there is a need of providing an environment and platform for network users to achieve benefits through the creation of their own values.

### SUMMARY

For solving the drawbacks of the conventional technologies, the present invention provides a demand matching method on network and a workspace trading platform using the method. By the demand matching method and the workspace trading platform of the present invention, any user can build and manage a workspace to get rewarded. Consequently, the inequality of contributing the “network profiles” to specified companies can be reduced. In other words, the present invention provides an environment and platform for network users to achieve benefits through the creation of their own values while possessing industrial values.

In accordance with an aspect of the present invention, there is provided a demand matching method on network. The demand matching method is executed by a machine with computational capability. The demand matching method on network includes the following steps. A first demand request is received from a first user. The first demand request corresponds to a business logic computation act, and an object of the business logic computation act is a workspace. A second demand request is received from a second user. If the first demand request and the second demand request accord with each other are matched, the business logic computation act corresponding to the first demand request is performed.

In an embodiment, the workspace is owned by the first user or the second user.

In an embodiment, the workspace is modeled by combining a plurality of unified matters together into a projectable space instance according to an operational demand, and the workspace is projected and provided to multiple cooperators. The projected workspace equips the plurality of unified matters according to the projectable space instance so as to allow at least two of the multiple cooperators to cooperatively implement a task.

In an embodiment, the demand matching method further includes a step of performing a valuating operation on the workspace according to at least one valuation parameter.

In an embodiment, the demand matching method further includes a step of ranking the first demand request, the second demand request or the workspace according to a result of the valuating operation.

In an embodiment, the at least one valuation parameter includes a relational valuation parameter, and the relational valuation parameter is related to a number, an identity and/or a stickiness of the multiple cooperators.

In an embodiment, the at least one valuation parameter further includes an operational demand valuation parameter, and the operational demand valuation parameter is related to an operational tendency of the operational demand.

In an embodiment, the at least one valuation parameter further includes an operational content valuation parameter, and the operational content valuation parameter is related to a click number and/or an assessment number of an operational content of the workspace.

In an embodiment, the business logic computation act is a lease act, a transaction act, a hire-of-work act or a mandate act.

In an embodiment, if the business logic computation act is the lease act, one of the first user and the second user is a lessor of the workspace, and the other of the first user and the second user is a lessee of the workspace. After the lease act is completed, a lease relation between the first user and the second user is established, and the lessor still has an ownership of the workspace. During continuance of the lease relation, the lessee has a right to manage at least a part of the workspace.

In an embodiment, if the business logic computation act is the lease act, one of the first user and the second user is a lessor to lease a relational list of the workspace to a lessee, and the other of the first user and the second user is the lessee to lease the relational list of the workspace from the lessor.

In an embodiment, the relational list of the workspace is a list compose of multiple cooperators related in the workspace.

In an embodiment, if the business logic computation act is the transaction act, one of the first user and the second user is a seller of the workspace, and the other of the first user and the second user is a buyer of the workspace. After the transaction act is completed, an ownership of the workspace is transferred from the seller to the buyer.

In an embodiment, if the business logic computation act is the hire-of-work act or the mandate act, one of the first user and the second user is an advertiser. After the hire-of-work act or the mandate act is completed, the other of the first user and the user provides an advertisement service for the advertiser through the workspace.

In an embodiment, the demand matching method further includes a step of generating a first demand catalogue corresponding to the first demand request or a workspace catalogue corresponding to the first demand request when the first demand request is received, and/or a step of generating a second demand catalogue corresponding to the second demand request or a workspace catalogue corresponding to the second demand request when the second demand request is received.

In an embodiment, the demand matching method further includes a step of providing a money flow unit, wherein the first user and/or the second user performs a money flow control operation corresponding to the business logic computation act.

In an embodiment, the workspace is a relational workspace or a relational synchronization workspace.

In an embodiment, at least one of the first user and the second user is a natural person, a company, an organization or a profit juristic person.

In accordance with another aspect of the present invention, there is provided a workspace trading platform. The workspace trading platform includes a receiving unit and an executing unit. The receiving unit receives a first demand request from a first user and a second demand request from a second user. The first demand request corresponds to a business logic computation act, and an object of the business logic computation act is a workspace. If the first demand request and the second demand request accord with each other are matched, the executing unit performs the business logic computation act corresponding to the first demand request.

In an embodiment, the workspace is owned by the first user or the second user.

In an embodiment, the workspace is modeled by combining a plurality of unified matters together into a projectable space instance according to an operational demand, and the workspace is projected and provided to multiple cooperators. The projected workspace equips the plurality of unified matters according to the projectable space instance so as to allow at least two of the multiple cooperators to cooperatively implement a task.

In an embodiment, the workspace trading platform further includes a valuating unit for performing a valuating operation on the workspace according to at least one valuation parameter.

In an embodiment, the workspace trading platform further includes a ranking unit for ranking the first demand request, the second demand request or the workspace according to a result of the valuating operation.

In an embodiment, the at least one valuation parameter includes a relational valuation parameter, and the relational valuation parameter is related to a number, an identity and/or a stickiness of the multiple cooperators.

In an embodiment, the at least one valuation parameter further includes an operational demand valuation parameter, and the operational demand valuation parameter is related to an operational tendency of the operational demand.

In an embodiment, the at least one valuation parameter further includes an operational content valuation parameter, and the operational content valuation parameter is related to a click number and/or an assessment number of an operational content of the workspace.

In an embodiment, the business logic computation act is a lease act, a transaction act, a hire-of-work act or a mandate act.

In an embodiment, if the business logic computation act is the lease act, one of the first user and the second user is a lessor of the workspace, and the other of the first user and the second user is a lessee of the workspace. After the lease act is completed by the executing unit, a lease relation between the first user and the second user is established. During continuance of the lease relation, a right to manage at least a part of the workspace is transferred from the lessor to the lessee by the executing unit.

In an embodiment, after the lease act is completed by the executing unit, the executing unit provides a relational list of the workspace to the lessee, and the relational list of the workspace is a list compose of multiple cooperators related in the workspace.

In an embodiment, if the business logic computation act is the transaction act, one of the first user and the second user is a seller of the workspace, and the other of the first user and the second user is a buyer of the workspace. After the transaction act is completed by the executing unit, an ownership of the workspace is transferred from the seller to the buyer by the executing unit.

In an embodiment, if the business logic computation act is the hire-of-work act or the mandate act, one of the first user and the second user is an advertiser. After the hire-of-work act or the mandate act is completed, the other of the first user and the user provides an advertisement service for the advertiser through the workspace. The workspace trading platform further includes an advertisement value calculation unit, and an advertisement value of the advertisement service is calculated by the advertisement value calculation unit.

In an embodiment, the workspace trading platform further includes a catalogue generating unit. The catalogue generating unit generates a first demand catalogue corresponding to the first demand request or a workspace catalogue corresponding to the first demand request when the first demand request is received by the receiving unit. The catalogue generating unit generates a second demand catalogue corresponding to the second demand request or a workspace catalogue corresponding to the second demand request when the second demand request is received by the receiving unit.

In an embodiment, the workspace trading platform further includes a money flow unit. The first user and/or the second user can perform a money flow control operation corresponding to the business logic computation act through the money flow unit.

In an embodiment, the workspace is a relational workspace or a relational synchronization workspace.

In an embodiment, at least one of the first user and the second user is a natural person, a company, an organization or a profit juristic person.

From the above descriptions, a person can have the ownership of the workspace, and the workspace can be an object of the business logic computation act. By the demand matching method and the workspace trading platform of the present invention, any user can build and manage a workspace to get rewarded. Consequently, the inequality of contributing the “network profiles” to specified companies can be reduced. In other words, the present invention provides an environment and platform for network users to achieve benefits through the creation of their own values while possessing industrial values.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating an implementation concept of a unifying method according to an embodiment;

FIG. 2 is a schematic diagram illustrating an implementation concept of using the unified script as an intermediate language for implementing the personal workspace;

FIG. 3 is a schematic diagram illustrating a preferred configuration of a personal workspace;

FIG. 4 is a schematic diagram illustrating an initial state of the method of projecting the workspace according to an embodiment of the present invention;

FIGS. 5A and 5B are schematic diagrams illustrating operating concepts of the method of projecting the workspace as shown in FIG. 4;

FIG. 6 is a schematic diagram illustrating the relationship between a projectable space instance as shown in FIG. 4 and a projected workspace as shown in FIG. 5B;

FIG. 7 is a flowchart illustrating a demand matching method on network according to an embodiment of the present invention;

FIG. 8 is a schematic functional diagram illustrating a first implementation example of a workspace trading platform using the demand matching method of FIG. 7;

FIG. 9 is a schematic diagram illustrating an implementation concept of performing a lease act through the demand matching method of FIG. 7 and the workspace trading platform of FIG. 8 according to the present invention;

FIG. 10 is a schematic diagram illustrating an implementation concept of performing a transaction act through the demand matching method of FIG. 7 and the workspace trading platform of FIG. 8 according to the present invention;

FIG. 11 is a schematic diagram illustrating an implementation concept of performing a hire-of-work act or a mandate act through the demand matching method of FIG. 7 and the workspace trading platform of FIG. 8 according to the present invention;

FIG. 12 is a schematic diagram illustrating a variant example of FIG. 11;

FIG. 13 is a schematic functional diagram illustrating a second implementation example of a workspace trading platform using the demand matching method of FIG. 7;

FIG. 14 is a schematic functional diagram illustrating a third implementation example of a workspace trading platform using the demand matching method of FIG. 7; and

FIG. 15 is a schematic functional diagram illustrating a fourth implementation example of a workspace trading platform using the demand matching method of FIG. 7.

### DETAILED DESCRIPTION

The present invention is more fully appreciated by reference to the following description, including the following glossary of terms and the concluding examples. For the sake of brevity, the disclosures of the publications, including patents, cited in this specification are herein incorporated by reference.

The examples below are non-limiting and are merely representative of various aspects and features of the present invention. The term “information source” used herein is defined as a sequence of symbols that can be interpreted as a message in the most limited technical meaning. And the message is used for organizing and labeling information. For example, the information source includes website (such as internet service), intranet, social network, software, electronic book, database and other media of information (such as storage media of non-transitory computer or storage media of mobile device). The term “original information” used herein is a file, a web page, a database row, a policy, a rule or any data accessible in a corresponding machine and server, but is not limited thereto. The term “original tool” used herein is a utility, a widget, an intelligent agent, an application, a service or any executable component accessible in a corresponding machine and server, but is not limited thereto. It is noted that the information sources, the original information and the original tool are not restricted to the above examples.

Moreover, “original information” and “original tool” are implementation examples of “original matters” used herein. In accordance with the present invention, a plurality of “original matters” from identical or different “information sources” are modeled to a plurality of “unified matters” by a unifying method. Consequently, the “unified matters” in the same execution environment are compatible with each other and cooperate to perform a specified task. The “unified tool” and the “unified information unit” are implementation examples of the “unified matters”. Moreover, the term “Matterizer” used herein is a means, a device or a program code to perform the unifying process.

In an embodiment, the above unifying method comprises steps of: modeling at least one original information obtained from at least one information source of multiple information sources into a unified information unit with one unified data model via re-organizing the original information, and/or modeling at least one original tool obtained from at least one information source of multiple information sources into a unified tool with another unified data model via re-organizing the original tool. The one unified data model and another unified data model could be identical or different, and the unifying method described above could be completed through a matterizer.

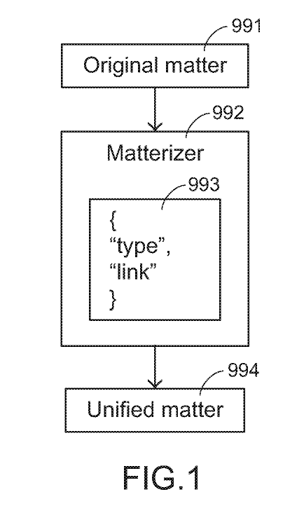

Please refer to FIG. 1. FIG. 1 is a schematic diagram illustrating an implementation concept of a unifying method according to an embodiment. As shown in FIG. 1, the matterizer 992 re-organizes an attribute and a link of an original matter 991 with a unified data model 993, and thus models the original matter 991 into a unified matter 994. Consequently, the basic attribute of the unified matter 994 include a type of the original matter 994 and a link indicating where the original matter 994 is located.

In this embodiment, the original matter 991 at least includes an original information (not shown) or an original tool (not shown), but is not limited thereto. In the above unifying method, if the attribute accessible from the original information corresponds to the attribute to be unified in the unified information unit, the unified information unit is directly produced through the matterizer 992. If the attribute accessible from the original information does not correspond to the attribute to be unified in the unified information unit, the original information is firstly re-defined by logically re-organizing the attributes and the link of the original information, and then the original information is converted into a new original information with the attributes which correspond to attributes to be unified in the unified information unit. Consequently, the unified information unit is indirectly produced.

Moreover, if the original tool is compatible with the working environment of the workspace, the unified tool is directly produced by the matterizer 992. On the other hand, if the original tool is incompatible with the working environment of the workspace, the unified tool is indirectly produced via an adapter and/or a software development kit (SDK) of the original tool to drive the original tool. The adapter provides an interface implementation compatible with the working environment.

Herein, “the descriptions of the unifying method”, “the methods of obtaining the unified matters” and “the descriptions of the matterizer” may be referred to the U.S. patent application Ser. No. 14/324,069, entitled “A method of unifying information and tool from a plurality of information sources”, and also referred to the China Patent Application No. 201410768564.X, which claims the benefit of priority to the U.S. patent application Ser. No. 14/324,069 and is entitled “A method of unifying information and tool from a plurality of information sources and computer product and device using the method”. The detailed descriptions thereof are omitted.

The above unifying method is presented herein for purpose of illustration and description only. The method of unifying a plurality of original matters from different information sources is not restricted. However, those skilled in the art will readily observe that numerous modifications and alterations may be made while retaining the teachings of the invention.

Hereinafter, two other unifying methods will be illustrated. The first unifying method is applied to a method of unifying the information of Garmin satellite navigation. Through a point-of-interest (POI) function of the Garmin satellite navigation, the method of unifying the information is employed to unify the imported original point information (i.e., an original information) into the corresponding unified point information (i.e., a unified information unit). The second unifying method is applied to a method of unifying the tool of an Android system. The Android system is a Linux-based open source mobile operating system. However, most application programs (i.e., original tools) are written in the Java programming language. Consequently, the application program (i.e., the original tool) written in the Java programming language can be modeled into a unified application program (i.e., the unified tool) compatible with the Android system so as to be executed in the Android system.

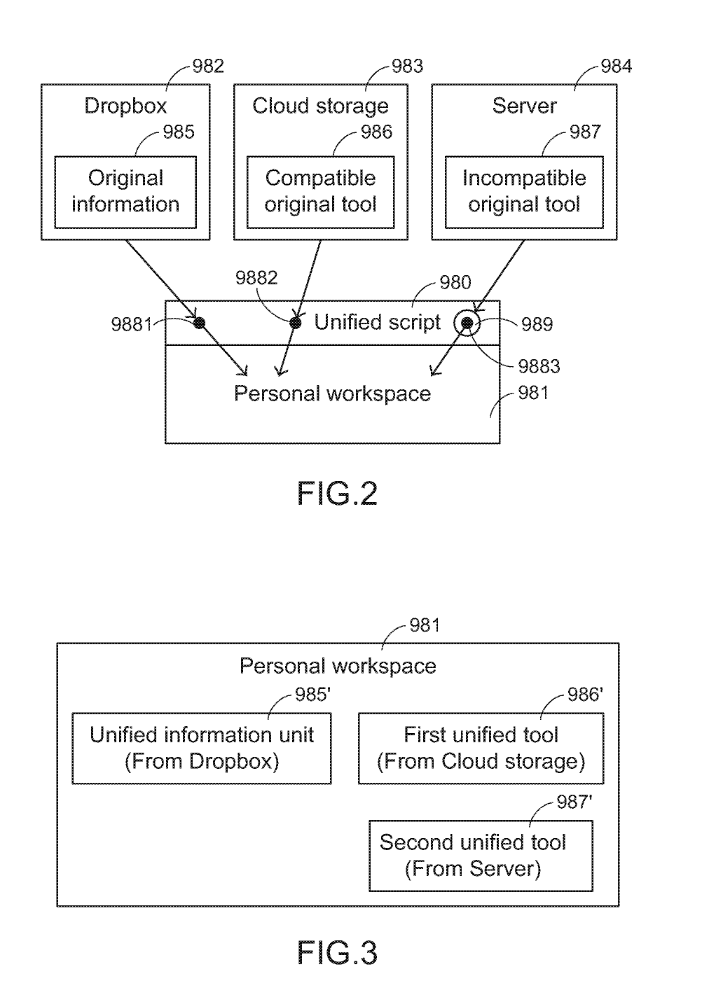

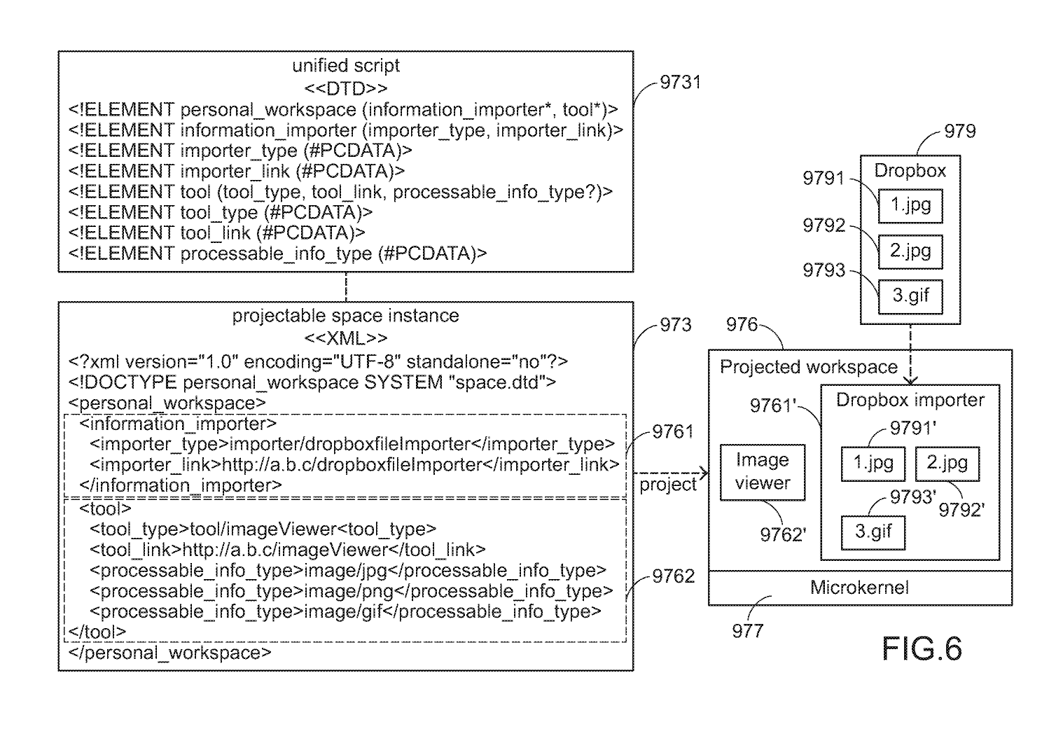

The term “workspace” used herein is a working environment for providing interactions between the at least one matterizer, the at least one tool and/or the at least one information so as to implement a specified task. Moreover, the at least one tool and/or at least one information can be imported into the workspace through the at least one matterizer. However, the way of importing the information and/or tool into the workspace is not restricted. Hereinafter, information importers such as the information importers 9881, 9882 and 9883 of FIG. 2 and the Dropbox importer 9761′ of FIG. 6 are some examples of the matterizer. The term “unified script” used herein is an intermediate language to implement the workspace. Moreover, via the “unified script”, the at least one matterizer, the at least one tool and/or the at least one information can be provided to the workspace (e.g., built in or plugged in the workspace).

In an embodiment, the above at least one information is a unified information unit which is produced after at least one original information obtained from at least one information source is unified, and the above at least one tool is a unified tool which is produced after at least one original tool obtained from at least one information source is unified. Moreover, according to different tasks, the required unified information unit and/or the required unified tool from the corresponding information source can be added to the personal workspace (e.g., built in or plugged in the personal workspace). In other words, the “workspace” is a user-orientated “personal workspace”.

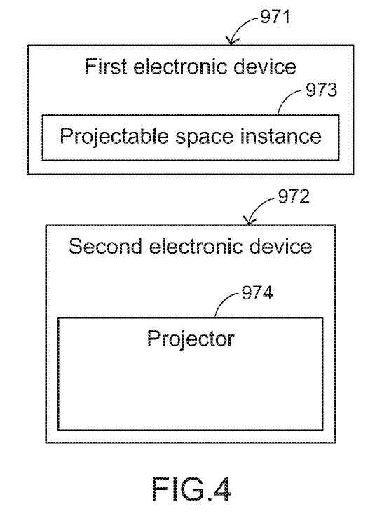

Please refer to FIG. 2 and FIG. 3. FIG. 2 is a schematic diagram illustrating an implementation concept of using the unified script as an intermediate language for implementing the personal workspace. FIG. 3 is a schematic diagram illustrating a preferred configuration of a personal workspace. As shown in FIG. 2 and FIG. 3, a unified information unit 985′ corresponding to an original information 985 in Dropbox 982, a first unified tool 986′ corresponding to a compatible original tool 986 in a cloud storage 983 and a second unified tool 987′ corresponding to an incompatible original tool 987 in a server 984 are combined together into a personal workspace 981 according to the required tasks. In particular, a unified script 980 which is regarded as an intermediate language for implementing the personal workspace 981 is firstly compiled, and then an information importer 9881 of the Dropbox 982, an information importer 9882 of the cloud storage 983 and an information importer 9883 of the server 984 are configured through the unified script 980. Moreover, after the original information 985 in the Dropbox 982 is unified into the unified information unit 985′ by the information importer 9881, the unified information unit 985′ is imported into the personal workspace 981.

As shown in FIG. 2 and FIG. 3, the original tool stored in the cloud storage 983 is the compatible original tool 986, which is compatible with the component architecture of the unified tool in the personal workspace 981. Moreover, the first unified tool 986′ corresponding to the compatible original tool 986 is directly provided to the personal workspace 981 through the information importer 9882 of the unified script 980.

As shown in FIG. 2 and FIG. 3, the original tool stored in the server 984 is the incompatible original tool 987, which is incompatible with the component architecture of the unified tool in the personal workspace 981. Moreover, the second unified tool 987′ corresponding to the incompatible original tool 987 is provided to the personal workspace 981 through the compatible adapter 989 and the information importer 9883 of the unified script 980.

As shown in FIG. 3, the user can configure and arrange (e.g., group or place) the unified information unit 985′, the first unified tool 986′ and the second unified tool 987′ in a specific area of the personal workspace 981 according to the practical requirements. Moreover, according to the operational relationship between the unified tool and the unified information unit (e.g., the clicking or dragging actions between the two), the user can perform specified tasks by using the unified tool to access or control the corresponding unified information unit.

Herein, “the descriptions of using the unified script as the intermediate language for implementing the personal workspace” and “the descriptions of allowing the required unified information unit and/or the required unified tool from the corresponding information sources to be arbitrarily combined together into the personal workspace according to the practical requirements” may be referred to the U.S. patent application Ser. No. 14/325,466, entitled “Method for performing task on unified information units in a personal workspace”, and also referred to the China Patent Application No. 201410796528.4, which claims the benefit of priority to the U.S. patent application Ser. Nos. 14/324,069 and 14/325,466 and is entitled “A method of combining unified matters in a personal workspace and computer product and device using the method”. The detailed descriptions thereof are omitted.

The above personal workspace is presented herein for purpose of illustration and description only. It is noted that the workspace used in the present invention is not restricted. For example, the unified script as the intermediate language for implementing the workspace can be previously edited. Consequently, the workspace has the default matterizer, the default information and/or the default tool. This workspace is not limited to be operated by a single user. According to the practical requirements, this workspace can be operated by multiple users at the same time or at different times.

Moreover, the “workspace” used herein is obtained by “a method of projecting a workspace” to any electronic device with computational capability. An example of the electronic device includes but is not limited to a mobile phone, a tablet computer, a notebook computer or a desktop computer. Consequently, the “projected workspace” can be operated by any user through any electronic device with computational capability.

In an embodiment, the method of projecting the workspace comprises the following steps. Firstly, a projectable space instance instantiated by the unified script is obtained through a uniform resource identifier (URI). As mentioned above, the unified script is defined to configure at least one of the matterizer, the information and the tool to model the workspace. Moreover, the projectable space instance is used to build the projected workspace corresponding to the workspace, and thus provide an interface for operating at least one of the matterizer, the information and the tool to implement a task. Then, a projector parses the projectable space instance and build a working environment to configure at least one of the matterizer, the information and the tool so as to execute the projected workspace for providing interactions between at least one user and the projected workspace.

The projector is acquired from a remote data station, the projectable space instance or a preloaded application program, and loaded into an engine for providing a compatible environment to execute the projector. An example of the engine includes but is not limited to a Javascript engine, a Windows application or a Linux application. Preferably but not exclusively, the united script can be declared by a document type definition (DTD), an extensible markup language (XML) Schema, a structured language or a structured protocol. Preferably but not exclusively, the projectable space instance is an object, an extensible markup language (XML) document, or an instance instantiated with a structured language or a structured protocol.

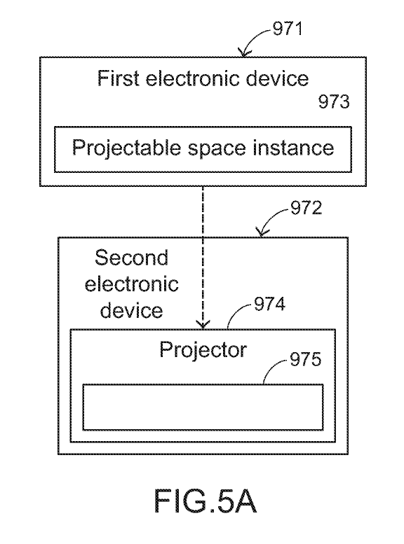

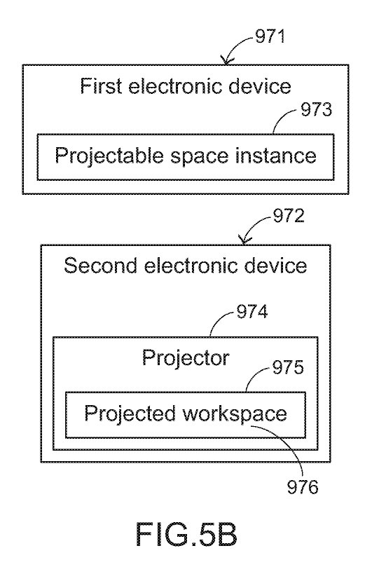

Please refer to FIG. 4, FIG. 5A, FIG. 5B and FIG. 6. FIG. 4 is a schematic diagram illustrating an initial state of the method of projecting the workspace according to an embodiment of the present invention. FIGS. 5A and 5B are schematic diagrams illustrating operating concepts of the method of projecting the workspace as shown in FIG. 4. FIG. 6 is a schematic diagram illustrating the relationship between a projectable space instance as shown in FIG. 4 and a projected workspace as shown in FIG. 5B.

In the initial state of FIG. 4, a first electronic device 971 and a second electronic device 972 are in communication with each other (e.g., through network connection). Moreover, the first electronic device 971 stores a projectable space instance 973, and the second electronic device 972 has a built-in projector 974.

In this embodiment, the united script 9731 is declared by a document type definition (DTD) and defined to configure at least one information importer (i.e., an example of the matterizer), at least one unified information unit and/or at least one unified tool to model a workspace, and the projectable space instance 973 is an instance instantiated with the extensible markup language (XML). As shown in FIG. 6, the projectable space instance 973 is used for building a projected workspace 976 corresponding to the workspace. Moreover, the information importer, the unified information and/or the unified tool is allowed to be added to or removed from the projectable space instance 973.

The projector 974 of the second electronic device 972 will build a working environment 975 in the second electronic device 972 for executing the projected workspace 976. In addition, the projector 974 provides a microkernel 977 (see FIG. 6) to the working environment 975 for equipping at least one information importer, at least one unified information and/or at least one unified tool that will be added to the projected workspace 976. When the second electronic device 972 acquires the projectable space instance 973 from the first electronic device 971 through a URI, the projector 974 of the second electronic device 972 starts to parse the projectable space instance 973 (see FIG. 5A). After the projectable space instance 973 is parsed by the projector 974, the projected workspace 976 is built in the working environment 975 according to parsed contents of the projectable space instance 973 (see FIG. 5B). Accordingly, a user of the second electronic device 972 can interact with the projected workspace 976 through the second electronic device 972 so as to perform related tasks.

The relationships between the unified script 9731, the projectable space instance 973 and the projected workspace 976 will be illustrated in more detailed through a usage situation as shown in FIG. 6. The usage situation as shown in FIG. 6 is related to a process of building a projected workspace that is capable of accessing jpg format image files and gif format image files from a specified internet space and allowing the image files to be viewed by a user. In this usage situation, the unified script 9731 is declared by the Document Type Definition (DTD), and the projectable space instance 973 is instantiated with XML.

Moreover, an information importer and a unified tool are added into the projectable space instance 973, and at least one unified information unit corresponding to the original information is imported into the projected workspace 976 through the information importer. In this usage situation, the information importer is a Dropbox importer. The information of the Dropbox importer is disclosed in the dashed line frame 9761 of FIG. 6. The original information includes a jpg format image file 9791, a jpg format image file 9792 and a gif format image file 9793 in Dropbox 979 (i.e., an information source). The unified information units includes a unified jpg format image file 9791′, a unified jpg format image file 9792′ and a unified gif format image file 9793′, which will be described later. The unified tool is an image viewer for accessing image files which are imported into the projected workspace 976. The information of the image viewer is disclosed in the dashed line frame 9762 of FIG. 6.

As mentioned above, the projected workspace 976 is built after the projectable space instance 973 is parsed by the projector 974 of the second electronic device 972. In this embodiment, the Dropbox importer 9761′ corresponding to the dashed line frame 9761 and the image viewer 9762′ corresponding to the dashed line frame 9762 are configured in the projected workspace 976. Moreover, the jpg format image file 9791, the jpg format image file 9792 and the gif format image file 9793 in Dropbox 979 are unified and imported into the projected workspace 976 by the Dropbox importer 9761′. Consequently, the unified jpg format image file 9791′ corresponding to the jpg format image file 9791, the unified jpg format image file 9792′ corresponding to the jpg format image file 9792 and the unified gif format image file 9793′ corresponding to the gif format image file 9793 are displayed on the projected workspace 976. When the user of the second electronic device 972 manipulates any of the unified image files 9791′, 9792′ and 9793′ by any specified operating means (such as an action of clicking any of the unified images files 9791′, 9792′ and 9793′ or an action of dragging and dropping any of the image files 9791′, 9792′ and 9793′ to the image viewer 9762′), the image viewer 9762′ will access the contents of the corresponding unified image files 9791′, 9792′ or 9793′ to allow the unified image files 9791′, 9792′ or 9793′ to be viewed by the user. Moreover, the Dropbox importer 9761′ and the image viewer 9762′ mentioned above are equipped by the microkernel 977.

It is noted that the URI of the projectable space instance 973 may be a HTTP (hypertext transfer protocol) URI or a FTP (file transfer protocol) URI. In case that the first electronic device 971 and the second electronic device 972 are integrated into one device, the URI of the projectable space instance 973 can also be a local file URI. However, the types of the URI of the projectable space instance 973 are not restricted.

Herein, “the descriptions of the method of projecting the workspace” may be referred to the U.S. patent application Ser. No. 14/577,772, entitled “Method of projecting a workspace and system using the same”, and also referred to the China Patent Application No. 201410814138.5, which claims the benefit of priority to the U.S. patent application Ser. Nos. 14/324,069, 14/325,466 and 14/577,772 and is entitled “Method of projecting a workspace and system using the same”. The detailed descriptions thereof are omitted.

The above method of projecting the workspace to any electronic device with computational capability is presented herein for purpose of illustration and description only. The method of projecting the workspace to any electronic device with computational capability is not restricted. However, those skilled in the art will readily observe that numerous modifications and alterations may be made while retaining the teachings of the invention.

Moreover, any workspace can be projected to any electronic device with computational capability. That is, any workspace can be delivered to any electronic device with computational capability. Consequently, any user has a relational connection with the workspace that is delivered by the user or the workspace that is received by the user. Moreover, the deliverer and the receiver of the same workspace may have a relational connection between each other. In other words, the workspace can be considered as a “relational workspace”. In particular, any user can establish a personal social relationship and a personal social network according to the “relational workspace”, and thus generate a “relational list”.

Since any workspace can be delivered to any electronic device with computational capability, the workspace can be formed as a synchronization platform for allowing multiple cooperators to cooperatively implement tasks. That is, the workspace is a “relational synchronization workspace”, and any cooperator is a member of the “relational list”. In an embodiment, the relational synchronization workspace is built by combining a plurality of unified matters together into a projectable space instance according to an operational demand. Moreover, the relational synchronization workspace can be projected and provided to multiple cooperators. Consequently, the projected relational synchronization workspace can equip the plurality of unified matters according to the projectable space instance in order to allow at least two of the multiple cooperators to cooperatively implement tasks. According to the operational demand, the at least two cooperators are related with each other.

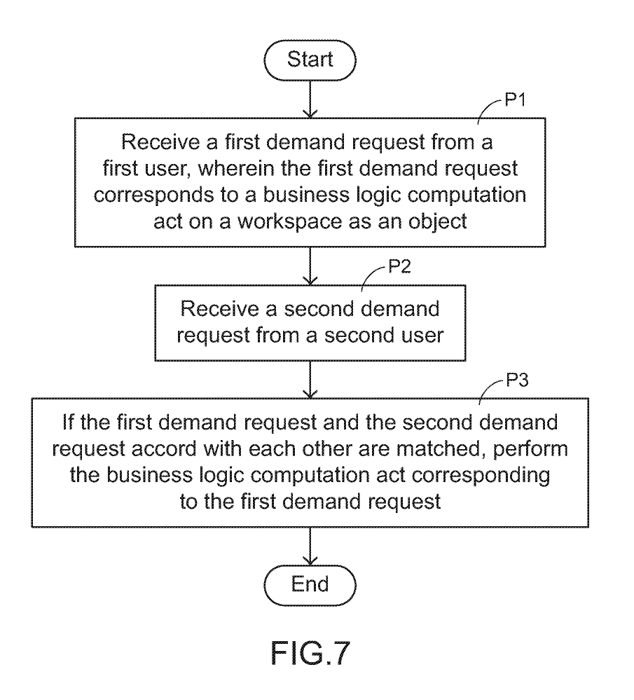

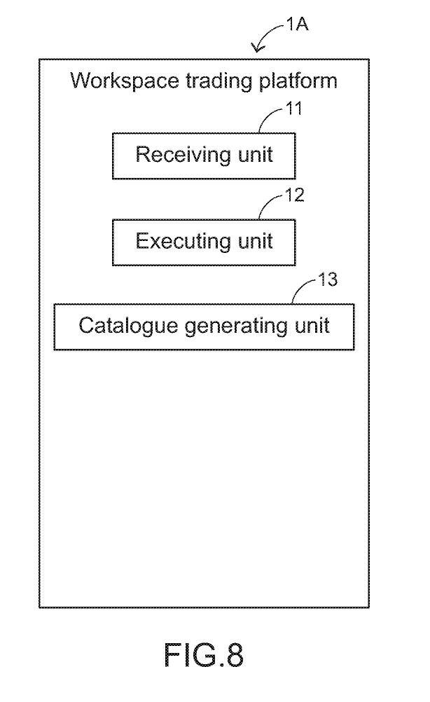

The present invention provides a demand matching method on network. Please refer to FIG. 7 and FIG. 8. FIG. 7 is a flowchart illustrating a demand matching method on network according to an embodiment of the present invention. FIG. 8 is a schematic functional diagram illustrating a first implementation example of a workspace trading platform using the demand matching method of FIG. 7. The demand matching method on network includes the following steps:

Step P1: Receive a first demand request from a first user, wherein the first demand request corresponds to a business logic computation act on a workspace as an object;

Step P2: Receive a second demand request from a second user; and

Step P3: If the first demand request and the second demand request accord with each other are matched, perform the business logic computation act corresponding to the first demand request.

Preferably but not exclusively, the first user providing the first demand request is a natural person, a company, an organization or a profit juristic person, and the second user providing the second demand request is also a natural person, a company, an organization or a profit juristic person. An example of the business logic computation act includes but is not limited to a lease act, a transaction act, a hire-of-work act or a mandate act. Moreover, the workspace is a relational workspace or a relational synchronization workspace, but is not limited thereto.

The workspace trading platform 1A of FIG. 8 is employed to perform the demand matching method of FIG. 7. The workspace trading platform 1A comprises a receiving unit 11, a catalogue generating unit 13 and an executing unit 12. The receiving unit 11 is used for receiving the first demand request from the first user and the second demand request from a second user. If the first demand request and the second demand request accord with each other are matched, the executing unit 12 performs the business logic computation act corresponding to the first demand request. After the receiving unit 11 receives the first demand request, the catalogue generating unit 13 generates a first demand catalogue corresponding to the first demand request or a workspace catalogue corresponding to the first demand request. Moreover, after the receiving unit 11 receives the second demand request, the catalogue generating unit 13 generates a second demand catalogue corresponding to the second demand request or a workspace catalogue corresponding to the second demand request.

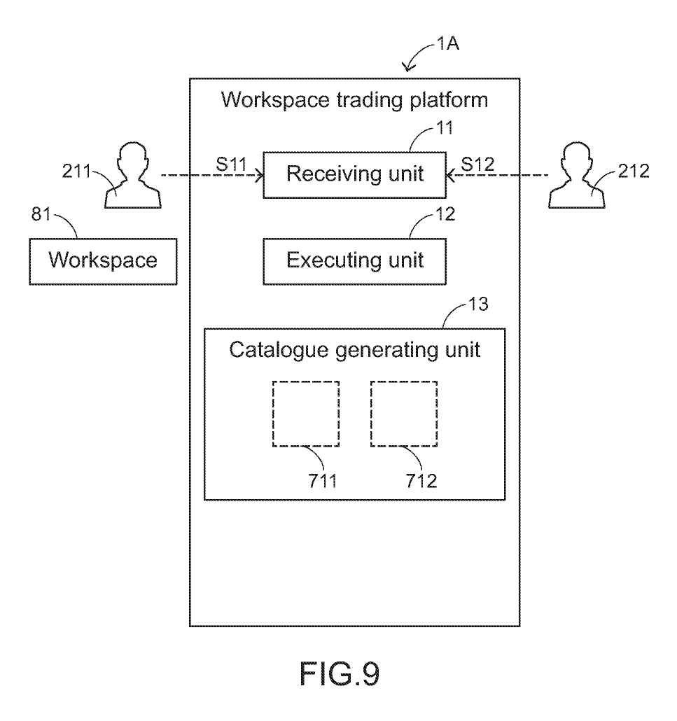

Hereinafter, the demand matching method will be illustrated by taking the lease act as an example of the business logic computation act. FIG. 9 is a schematic diagram illustrating an implementation concept of performing a lease act through the demand matching method of FIG. 7 and the workspace trading platform of FIG. 8 according to the present invention. In FIG. 9, the first user is a lessor 211 with an ownership of a workspace 81. When the lessor 211 intends to lease the workspace 81 to someone, a first demand request S11 corresponding to “a demand of leasing the workspace 81 to someone” is firstly transmitted from the lessor 211 to the workspace trading platform 1A. After the receiving unit 11 receives the first demand request S11, the catalogue generating unit 13 generates a first demand catalogue 711 corresponding to the first demand request S11 or a workspace catalogue (not shown) corresponding to the first demand request S11. Consequently, other user who logins in the workspace trading platform 1A (e.g., a lessee 212 for leasing a workspace from someone) can search or browse the first demand catalogue 711 or the workspace catalogue.

As shown in FIG. 9, the second user is the lessee 212 for leasing the workspace 81. Then, a second demand request S12 corresponding to “a demand of leasing a workspace from someone” is transmitted from the lessee 212 to the workspace trading platform 1A. After the receiving unit 11 receives the second demand request S12, the catalogue generating unit 13 generates a second demand catalogue 712 corresponding to the second demand request S12 or a workspace catalogue (not shown) corresponding to the second demand request S12. Consequently, other user who logins in the workspace trading platform 1A (e.g., the lessor 211 for leasing the workspace to someone) can search or browse the second demand catalogue 712 or the workspace catalogue.

A first implementation example of the lease act as shown in FIG. 9 will be illustrated as follows. For example, the workspace which the lessee 212 intends to lease accords with the workspace 81 to be leased by the lessor 211. Consequently, the executing unit 12 judges that the first demand request S11 and the second demand request S12 accord with each other are matched. Meanwhile, the executing unit 12 of the workspace trading platform 1A performs the lease act corresponding to the first demand request S11. In addition, a lease relation between the lessor 211 and the lessee 212 is established. The lessor 211 still has the ownership of the leased workspace 81. During the continuance of the lease relation, the lessee 212 has the right to manage at least a part of the workspace 81.

A second implementation example of the lease act as shown in FIG. 9 will be illustrated as follows. Firstly, the lessor 211 searches or browses the second demand catalogue 712 or the workspace catalogue (not shown) corresponding to the second demand request S12 through the workspace trading platform 1A. If the lessor 211 finds that the second demand catalogue 712 or the workspace catalogue accords with the workspace 81 to be leased, the lessor 211 can perform a specified confirmation action (e.g., a clicking action) to express that the first demand request S11 and the second demand request S12 accord with each other are matched. In response to the confirmation action, the executing unit 12 of the workspace trading platform 1A performs the lease act corresponding to the first demand request S11. Meanwhile, a lease relation between the lessor 211 and the lessee 212 is established. The lessor 211 still has the ownership of the leased workspace 81. During the continuance of the lease relation, the lessee 212 has the right to manage at least a part of the workspace 81.

A third implementation example of the lease act as shown in FIG. 9 will be illustrated as follows. Firstly, the lessee 212 searches or browses the first demand catalogue 711 or the workspace catalogue (not shown) corresponding to the first demand request S11 through the workspace trading platform 1A. If the first demand catalogue 711 or the workspace catalogue accords with the workspace which the lessee 212 intends to lease, the lessee 212 can perform a specified confirmation action (e.g., a clicking action) to express that the first demand request S11 and the second demand request S12 accord with each other are matched. In response to the confirmation action, the executing unit 12 of the workspace trading platform 1A performs the lease act corresponding to the first demand request S11. Meanwhile, a lease relation between the lessor 211 and the lessee 212 is established. The lessor 211 still has the ownership of the leased workspace 81. During the continuance of the lease relation, the lessee 212 has the right to manage at least a part of the workspace 81.

Preferably but not exclusively, after the lease relation between the lessor 211 and the lessee 212 is established, the lessor 211 is a lessor in the relational list of the workspace and the lessee 212 is a lessee in the relational list of the workspace. In FIG. 9, the first user 211 and the second user 212 are the lessor and the lessee, respectively. It is noted that the statuses of the first user and the second user are not restricted. For example, in another embodiment, the first user and the second user are respectively the lessee and the lessor, and the second user has the ownership of the workspace 81.

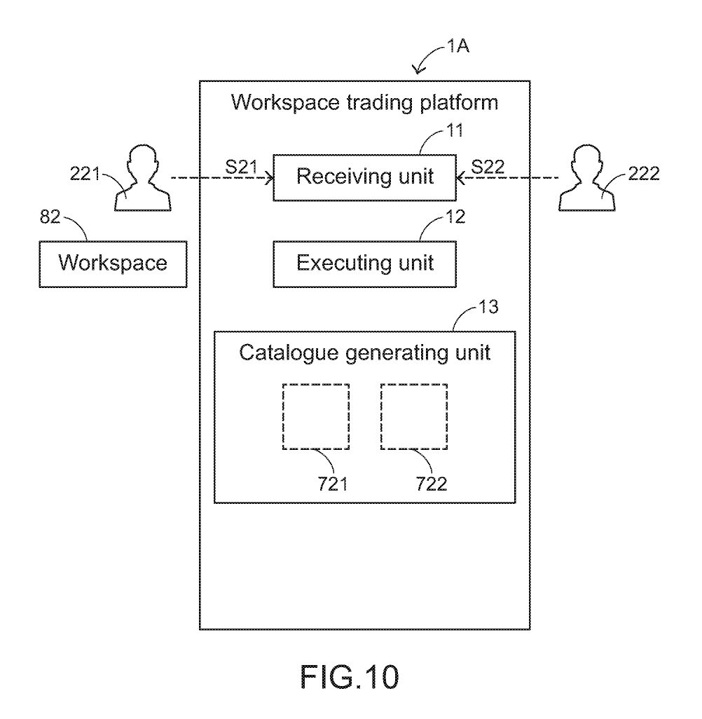

Hereinafter, the demand matching method will be illustrated by taking the transaction act as an example of the business logic computation act. FIG. 10 is a schematic diagram illustrating an implementation concept of performing a transaction act through the demand matching method of FIG. 7 and the workspace trading platform of FIG. 8 according to the present invention. In FIG. 10, the first user is a seller 221 with an ownership of a workspace 82. When the seller 221 intends to sell the workspace 82, a first demand request S21 corresponding to “a demand of selling the workspace 82” is firstly transmitted from the seller 221 to the workspace trading platform 1A. After the receiving unit 11 receives the first demand request S21, the catalogue generating unit 13 generates a first demand catalogue 721 corresponding to the first demand request S21 or a workspace catalogue (not shown) corresponding to the first demand request S21. Consequently, other user who logins in the workspace trading platform 1A (e.g., a buyer 222 for buying a workspace) can search or browse the first demand catalogue 721 or the workspace catalogue.

As shown in FIG. 10, the second user is the buyer 222 for buying a workspace. Then, a second demand request S22 corresponding to “a demand of buying a workspace” is transmitted from the buyer 222 to the workspace trading platform 1A. After the receiving unit 11 receives the second demand request S22, the catalogue generating unit 13 generates a second demand catalogue 722 corresponding to the second demand request S22 or a workspace catalogue (not shown) corresponding to the second demand request S22. Consequently, other user who logins in the workspace trading platform 1A (e.g., the seller 221 for selling the workspace) can search or browse the second demand catalogue 722 or the workspace catalogue. In FIG. 10, the first user and the second user are the seller 221 and the buyer 222, respectively. It is noted that the statuses of the first user and the second user are not restricted. For example, in another embodiment, the first user and the second user are respectively the buyer 222 and the seller 221, and the second user has the original ownership of the workspace 82.

A first implementation example of the transaction act as shown in FIG. 10 will be illustrated as follows. For example, the workspace which the buyer 222 intends to buy accords with the workspace 82 to be sold by the seller 221. Consequently, the executing unit 12 judges that the first demand request S21 and the second demand request S22 accord with each other are matched. Meanwhile, the executing unit 12 of the workspace trading platform 1A performs the transaction act corresponding to the first demand request S21. Consequently, the ownership of the workspace 82 is transferred from the seller 221 to the buyer 222.

A second implementation example of the transaction act as shown in FIG. 10 will be illustrated as follows. Firstly, the seller 221 searches or browses the second demand catalogue 722 or the workspace catalogue (not shown) corresponding to the second demand request S22 through the workspace trading platform 1A. If the seller 221 finds that the second demand catalogue 722 or the workspace catalogue accords with the workspace 82 to be sold, the seller 221 can perform a specified confirmation action (e.g., a clicking action) to express that the first demand request S21 and the second demand request S22 accord with each other are matched. In response to the confirmation action, the executing unit 12 of the workspace trading platform 1A performs the transaction act corresponding to the first demand request S21. Consequently, the ownership of the workspace 82 is transferred from the seller 221 to the buyer 222.

A third implementation example of the transaction act as shown in FIG. 10 will be illustrated as follows. Firstly, the buyer 222 searches or browses the first demand catalogue 721 or the workspace catalogue (not shown) corresponding to the first demand request S21 through the workspace trading platform 1A. If the buyer 222 finds that the first demand catalogue 721 or the workspace catalogue accords with the workspace which the buyer 222 intends to buy, the buyer 222 can perform a specified confirmation action (e.g., a clicking action) to express that the first demand request S21 and the second demand request S22 accord with each other are matched. In response to the confirmation action, the executing unit 12 of the workspace trading platform 1A performs the transaction act corresponding to the first demand request S21. Consequently, the ownership of the workspace 82 is transferred from the seller 221 to the buyer 222.

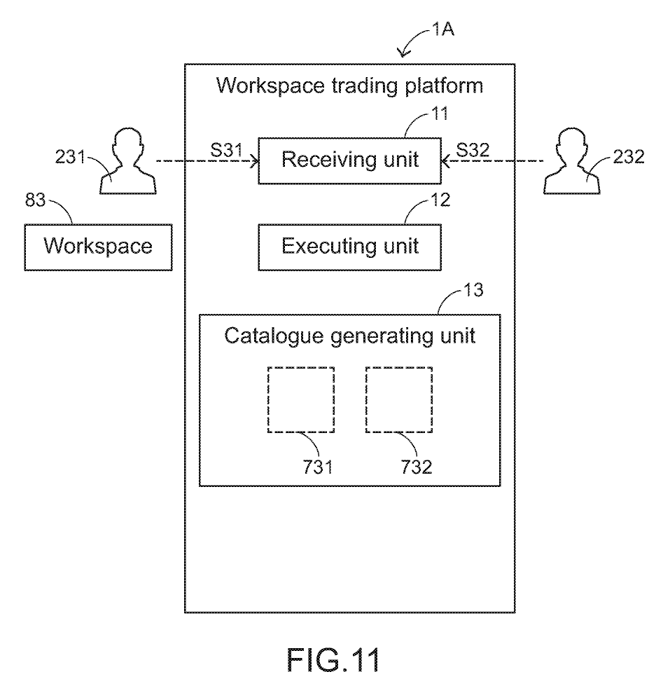

Hereinafter, the demand matching method will be illustrated by taking the hire-of-work or mandate act as an example of the business logic computation act. FIG. 11 is a schematic diagram illustrating an implementation concept of performing a hire-of-work act or a mandate act through the demand matching method of FIG. 7 and the workspace trading platform of FIG. 8 according to the present invention. In FIG. 11, the first user is an advertisement service provider 231 with an ownership or a management right of a workspace 83. When the advertisement service provider 231 intends to provide an advertisement service through the workspace 83, a first demand request S31 corresponding to “a demand of providing the advertisement service” is firstly transmitted from the advertisement service provider 231 to the workspace trading platform 1A. After the receiving unit 11 receives the first demand request S31, the catalogue generating unit 13 generates a first demand catalogue 731 corresponding to the first demand request S31 or a workspace catalogue (not shown) corresponding to the first demand request S31. Consequently, other user who logins in the workspace trading platform 1A (e.g., an advertiser 232 for posting an advertisement) can search or browse the first demand catalogue 731 or the workspace catalogue.

As shown in FIG. 11, the second user is the advertiser 232 for posting an advertisement. Then, a second demand request S32 corresponding to “a demand of posting an advertisement” is transmitted from the advertiser 232 to the workspace trading platform 1A. After the receiving unit 11 receives the second demand request S32, the catalogue generating unit 13 generates a second demand catalogue 732 corresponding to the second demand request S32 or a workspace catalogue (not shown) corresponding to the second demand request S32. Consequently, other user who logins in the workspace trading platform 1A (e.g., the advertisement service provider 231 for providing the advertisement) can search or browse the second demand catalogue 732 or the workspace catalogue. In FIG. 11, the first user and the second user are the advertisement service provider 231 and the advertiser 232, respectively. It is noted that the statuses of the first user and the second user are not restricted. For example, in another embodiment, the first user and the second user are respectively the advertiser 232 and the advertisement service provider 231, and the second user has the original ownership of the workspace 83.

A first implementation example of the hire-of-work or mandate act as shown in FIG. 11 will be illustrated as follows. For example, the advertisement which the advertiser 232 intends to post accords with the advertisement service norm (e.g., the advertisement type) to be provided to the workspace 83 by the advertisement service provider 231. Consequently, the executing unit 12 judges that the first demand request S31 and the second demand request S32 accord with each other are matched. Moreover, if the executing unit 12 judges that the form of the workspace 83 for providing the advertisement service by the advertisement service provider 231 accords with the form of the location of posting the advertisement by the advertiser 232, the executing unit 12 of the workspace trading platform 1A performs the hire-of-work or mandate act corresponding to the first demand request S31. In addition, a hire-of-work mandate relation between the advertisement service provider 231 and the advertiser 232 is established. During the continuance of the hire-of-work mandate relation, the advertisement service provider 231 with the ownership or the management right of the workspace 83 provides the advertisement service to the advertiser 232.

A second implementation example of the hire-of-work or mandate act as shown in FIG. 11 will be illustrated as follows. Firstly, the advertisement service provider 231 for providing an advertisement service searches or browses the second demand catalogue 722 or the workspace catalogue (not shown) corresponding to the second demand request S32 through the workspace trading platform 1A. If the advertisement service provider 231 finds that the second demand catalogue 732 or the workspace catalogue accords with the advertisement service norm (e.g., the advertisement type) to be provided to the workspace 83, the advertisement service provider 231 can perform a specified confirmation action (e.g., a clicking action) to express that the first demand request S31 and the second demand request S32 accord with each other are matched. In response to the confirmation action, the executing unit 12 of the workspace trading platform 1A performs the hire-of-work or mandate act corresponding to the first demand request S31. In addition, a hire-of-work mandate relation between the advertisement service provider 231 and the advertiser 232 is established. During the continuance of the hire-of-work mandate relation, the advertisement service provider 231 with the ownership or the management right of the workspace 83 provides the advertisement service to the advertiser 232.

A third implementation example of the hire-of-work or mandate act as shown in FIG. 11 will be illustrated as follows. Firstly, the advertiser 232 searches or browses the first demand catalogue 731 or the workspace catalogue (not shown) corresponding to the first demand request S31 through the workspace trading platform 1A. If the advertiser 232 finds that the first demand catalogue 731 or the workspace catalogue accords with the form of the location of posting the advertisement, the advertiser 232 can perform a specified confirmation action (e.g., a clicking action) to express that the first demand request S31 and the second demand request S32 accord with each other are matched. In response to the confirmation action, the executing unit 12 of the workspace trading platform 1A performs the hire-of-work or mandate act corresponding to the first demand request S31. In addition, a hire-of-work mandate relation between the advertisement service provider 231 and the advertiser 232 is established. During the continuance of the hire-of-work mandate relation, the advertisement service provider 231 with the ownership or the management right of the workspace 83 provides the advertisement service to the advertiser 232.

In the above business logic computation act, the catalogue generating unit 13 is only an optional component of the workspace trading platform 1A. Moreover, the step of generating the first demand catalogue 711, 721 or 731, the step of generating the workspace catalogue corresponding to the first demand request S11, S21 or S31, the step of generating the second demand catalogue 712, 722 or 732 and the step of generating the workspace catalogue corresponding to the second demand request S12, S22 or S32 are optional steps of the demand matching method on network according to the present invention. That is, in some other embodiments, the workspace trading platform 1A does not generate any catalogue to be searched or browsed by the first user or the second user. Instead, the first demand request S11, S21 or S31 of the first user and the second demand request S12, S22 or S32 of the user are directly matched through the executing unit 12 of the workspace trading platform 1A. If the executing unit 12 finds that the first demand request S11, S21 or S31 and the second demand request S12, S22 or S32 accord with each other are matched, the business logic computation act is completed.

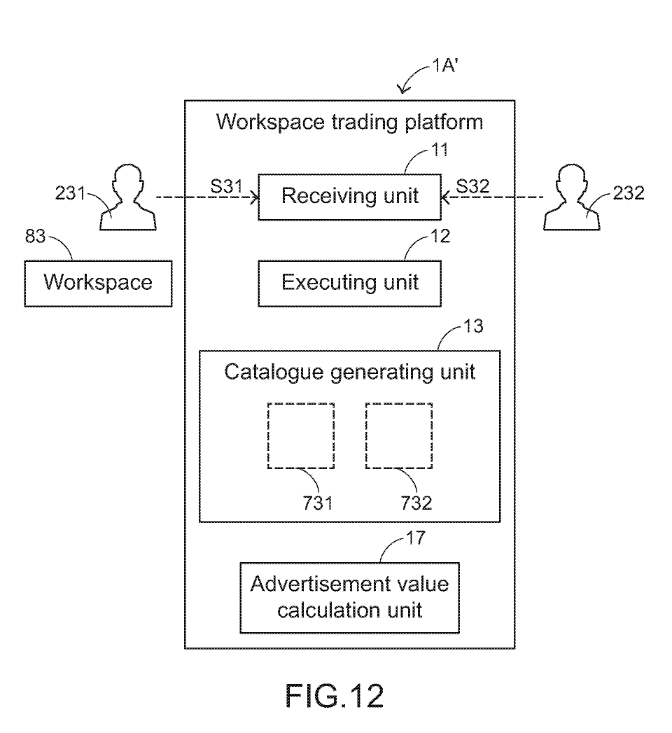

FIG. 12 is a schematic diagram illustrating a variant example of FIG. 11. As shown in FIG. 12, the workspace trading platform 1A′ further comprises an advertisement value calculation unit 17. The advertisement value calculation unit 17 is used for calculating the advertisement value of the advertisement service provided by the workspace 83, which is owned or managed by the advertisement service provider 231. For example, the advertisement value is assessed by calculating a click-through rate (CTR). Consequently, the advertisement service price paid from the advertiser 232 to the advertisement service provider 231 can be determined according to the advertisement value.

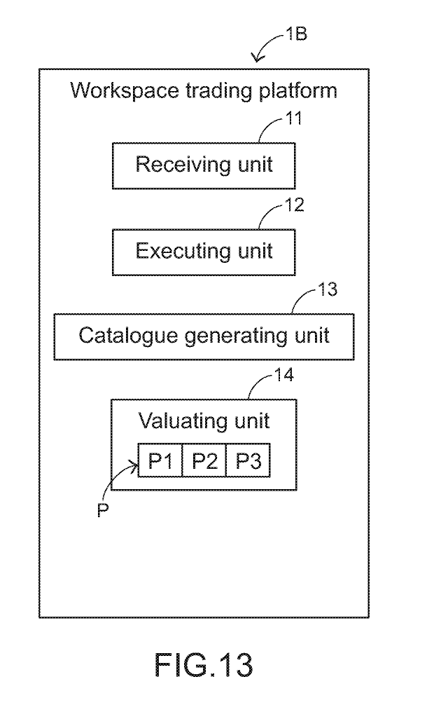

FIG. 13 is a schematic functional diagram illustrating a second implementation example of a workspace trading platform using the demand matching method of FIG. 7. In comparison with the workspace trading platform 1A, the workspace trading platform 1B of this embodiment further comprises a valuating unit 14. The other components of the workspace trading platform 1B are similar to those of the workspace trading platform 1A, and are not redundantly described herein. The valuating unit 14 performs a valuating operation on the workspace as an object of the business logic computation act according to at least one valuation parameter P. In other words, the demand matching method of FIG. 7 further comprises a step of performing a valuating operation on the workspace according to at least one valuation parameter P.

In an embodiment, the at least one valuation parameter P includes a relational valuation parameter P1. The relational valuation parameter P1 is related to a number, an identity and/or a stickiness of the cooperators of the workspace, but is not limited thereto. The at least one valuation parameter P further includes an operational demand valuation parameter P2. The operational demand valuation parameter P2 is related to an operational tendency of the operational demand, but is not limited thereto. The at least one valuation parameter P further includes an operational content valuation parameter P3. The operational content valuation parameter P3 is related to a click number and/or an assessment number of an operational content of the workspace, but is not limited thereto.

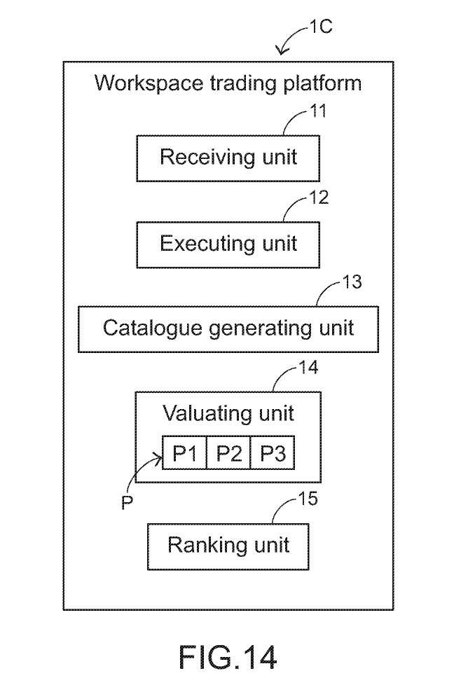

FIG. 14 is a schematic functional diagram illustrating a third implementation example of a workspace trading platform using the demand matching method of FIG. 7. In comparison with the workspace trading platform 1B, the workspace trading platform 1C of this embodiment further comprises a ranking unit 15. The other components of the workspace trading platform 1C are similar to those of the workspace trading platform 1B, and are not redundantly described herein. According to the result of the valuating operation, the ranking unit 15 ranks the first demand request, the second demand request or the workspace (i.e., an object of the business logic computation act). In other words, the demand matching method of FIG. 7 further comprises a step of ranking the first demand request, the second demand request or the workspace according to the result of the valuating operation. Preferably but not exclusively, the approach of ranking the first demand request, the second demand request or the workspace according to the result of the valuating operation includes the following purposes. For example, the first demand catalogue or the workspace catalogue corresponding to the first demand request is ranked, and/or the second demand catalogue or the workspace catalogue corresponding to the second demand request is ranked. The ranking result is helpful for the first user or the second user to search or browse workspace trading platform 1C, and thus the reliability of matching the demands is enhanced.

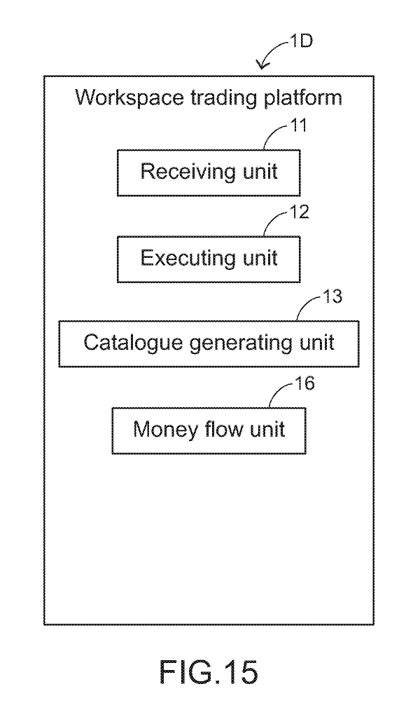

FIG. 15 is a schematic functional diagram illustrating a fourth implementation example of a workspace trading platform using the demand matching method of FIG. 7. In comparison with the workspace trading platform 1A, the workspace trading platform 1D of this embodiment further comprises a money flow unit 16. The other components of the workspace trading platform 1D are similar to those of the workspace trading platform 1A, and are not redundantly described herein. Through the money flow unit 16, the first user and/or the second user performs a money flow control operation corresponding to the business logic computation act.

For example, if the lessor 211 and the lessee 212 perform a lease act through the workspace trading platform 1D, the rental can be paid from the lessee 212 to the lessor 211 through the money flow unit 16. Similarly, if the buyer 222 and the seller 221 perform a transaction act through the workspace trading platform 1D, the sale price can be paid from the buyer 222 to the seller 221 through the money flow unit 16. Similarly, if the advertisement service provider 231 and the advertiser 232 perform the hire-of-work or mandate act, the advertisement service price can be paid from the advertiser 232 to the advertisement service provider 231 through the money flow unit 16. Of course, the money flow unit 16 can be applied to the workspace trading platform 1B or the workspace trading platform 1C.

From the above descriptions, a person can have the ownership of the workspace, and the workspace can be an object of the business logic computation act. By the demand matching method and the workspace trading platform of the present invention, any user can build and manage a workspace to get rewarded. Consequently, the inequality of contributing the “network profiles” to specified companies can be reduced. In other words, the present invention provides an environment and platform for network users to achieve benefits through the creation of their own values while possessing industrial values.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A demand matching method on network, executed by a machine with computational capability, the demand matching method on network comprising steps of:
receiving a first demand request from a first user, wherein the first demand request corresponds to a business logic computation act, and an object of the business logic computation act is a workspace;
receiving a second demand request from a second user; and
if the first demand request and the second demand request accord with each other are matched, performing the business logic computation act corresponding to the first demand request.

2. The demand matching method on network according to claim 1, wherein the workspace is owned by the first user or the second user.

3. The demand matching method on network according to claim 1, wherein the workspace is modeled by combining a plurality of unified matters together into a projectable space instance according to an operational demand, and the workspace is projected and provided to multiple cooperators, wherein the projected workspace equips the plurality of unified matters according to the projectable space instance so as to allow at least two of the multiple cooperators to cooperatively implement a task.

4. The demand matching method on network according to claim 3, further comprising a step of performing a valuating operation on the workspace according to at least one valuation parameter.

5. The demand matching method on network according to claim 4, further comprising a step of ranking the first demand request, the second demand request or the workspace according to a result of the valuating operation.

6. The demand matching method on network according to claim 4, wherein the at least one valuation parameter includes a relational valuation parameter, and the relational valuation parameter is related to a number, an identity and/or a stickiness of the multiple cooperators.

7. The demand matching method on network according to claim 4, wherein the at least one valuation parameter further includes an operational demand valuation parameter, and the operational demand valuation parameter is related to an operational tendency of the operational demand.

8. The demand matching method on network according to claim 4, wherein the at least one valuation parameter further includes an operational content valuation parameter, and the operational content valuation parameter is related to a click number and/or an assessment number of an operational content of the workspace.

9. The demand matching method on network according to claim 1, wherein the business logic computation act is a lease act, a transaction act, a hire-of-work act or a mandate act.

10. The demand matching method on network according to claim 9, wherein if the business logic computation act is the lease act, one of the first user and the second user is a lessor of the workspace, and the other of the first user and the second user is a lessee of the workspace, wherein after the lease act is completed, a lease relation between the first user and the second user is established, and the lessor still has an ownership of the workspace, wherein during continuance of the lease relation, the lessee has a right to manage at least a part of the workspace.

11. The demand matching method on network according to claim 9, wherein if the business logic computation act is the lease act, one of the first user and the second user is a lessor to lease a relational list of the workspace to a lessee, and the other of the first user and the second user is the lessee to lease the relational list of the workspace from the lessor.

12. The demand matching method on network according to claim 9, wherein the relational list of the workspace is a list compose of multiple cooperators related in the workspace.

13. The demand matching method on network according to claim 9, wherein if the business logic computation act is the transaction act, one of the first user and the second user is a seller of the workspace, and the other of the first user and the second user is a buyer of the workspace, wherein after the transaction act is completed, an ownership of the workspace is transferred from the seller to the buyer.

14. The demand matching method on network according to claim 9, wherein if the business logic computation act is the hire-of-work act or the mandate act, one of the first user and the second user is an advertiser, wherein after the hire-of-work act or the mandate act is completed, the other of the first user and the user provides an advertisement service for the advertiser through the workspace.

15. The demand matching method on network according to claim 1, further comprising a step of generating a first demand catalogue corresponding to the first demand request or a workspace catalogue corresponding to the first demand request when the first demand request is received, and/or a step of generating a second demand catalogue corresponding to the second demand request or a workspace catalogue corresponding to the second demand request when the second demand request is received.

16. The demand matching method on network according to claim 1, further comprising a step of providing a money flow unit, wherein the first user and/or the second user performs a money flow control operation corresponding to the business logic computation act.

17. The demand matching method on network according to claim 1, wherein the workspace is a relational workspace or a relational synchronization workspace.

18. The demand matching method on network according to claim 1, wherein at least one of the first user and the second user is a natural person, a company, an organization or a profit juristic person.

19. A workspace trading platform, comprising:
a receiving unit receiving a first demand request from a first user and a second demand request from a second user, wherein the first demand request corresponds to a business logic computation act, and an object of the business logic computation act is a workspace; and
an executing unit, wherein if the first demand request and the second demand request accord with each other are matched, the executing unit performs the business logic computation act corresponding to the first demand request.

20. The workspace trading platform according to claim 19, wherein the workspace is owned by the first user or the second user.

21. The workspace trading platform according to claim 19, wherein the workspace is modeled by combining a plurality of unified matters together into a projectable space instance according to an operational demand, and the workspace is projected and provided to multiple cooperators, wherein the projected workspace equips the plurality of unified matters according to the projectable space instance so as to allow at least two of the multiple cooperators to cooperatively implement a task.

22. The workspace trading platform according to claim 21, further comprising a valuating unit, wherein the valuating unit performs a valuating operation on the workspace according to at least one valuation parameter.

23. The workspace trading platform according to claim 22, further comprises a ranking unit, wherein the ranking unit ranks the first demand request, the second demand request or the workspace according to a result of the valuating operation.

24. The workspace trading platform according to claim 22, wherein the at least one valuation parameter includes a relational valuation parameter, and the relational valuation parameter is related to a number, an identity and/or a stickiness of the multiple cooperators.

25. The workspace trading platform according to claim 22, wherein the at least one valuation parameter further includes an operational demand valuation parameter, and the operational demand valuation parameter is related to an operational tendency of the operational demand.

26. The workspace trading platform according to claim 22, wherein the at least one valuation parameter further includes an operational content valuation parameter, and the operational content valuation parameter is related to a click number and/or an assessment number of an operational content of the workspace.

27. The workspace trading platform according to claim 19, wherein the business logic computation act is a lease act, a transaction act, a hire-of-work act or a mandate act.

28. The workspace trading platform according to claim 27, wherein if the business logic computation act is the lease act, one of the first user and the second user is a lessor of the workspace, and the other of the first user and the second user is a lessee of the workspace, wherein after the lease act is completed by the executing unit, a lease relation between the first user and the second user is established, wherein during continuance of the lease relation, a right to manage at least a part of the workspace is transferred from the lessor to the lessee by the executing unit.

29. The workspace trading platform according to claim 27, wherein after the lease act is completed by the executing unit, the executing unit provides a relational list of the workspace to the lessee, wherein the relational list of the workspace is a list compose of multiple cooperators related in the workspace.

30. The workspace trading platform according to claim 27, wherein if the business logic computation act is the transaction act, one of the first user and the second user is a seller of the workspace, and the other of the first user and the second user is a buyer of the workspace, wherein after the transaction act is completed by the executing unit, an ownership of the workspace is transferred from the seller to the buyer by the executing unit.

31. The workspace trading platform according to claim 27, wherein if the business logic computation act is the hire-of-work act or the mandate act, one of the first user and the second user is an advertiser, wherein after the hire-of-work act or the mandate act is completed, the other of the first user and the user provides an advertisement service for the advertiser through the workspace, wherein the workspace trading platform further comprises an advertisement value calculation unit, and an advertisement value of the advertisement service is calculated by the advertisement value calculation unit.

32. The workspace trading platform according to claim 19, further comprising a catalogue generating unit, wherein the catalogue generating unit generates a first demand catalogue corresponding to the first demand request or a workspace catalogue corresponding to the first demand request when the first demand request is received by the receiving unit, and/or the catalogue generating unit generates a second demand catalogue corresponding to the second demand request or a workspace catalogue corresponding to the second demand request when the second demand request is received by the receiving unit.

33. The workspace trading platform according to claim 19, further comprising a money flow unit, wherein the first user and/or the second user performs a money flow control operation corresponding to the business logic computation act through the money flow unit.

34. The workspace trading platform according to claim 19, wherein the workspace is a relational workspace or a relational synchronization workspace.

35. The workspace trading platform according to claim 19, wherein at least one of the first user and the second user is a natural person, a company, an organization or a profit juristic person.
